(19) United States
(12) Patent Application Publication
(10) Pub. No.: US 2020/0033988 A1
(43) Pub. Date: Jan. 30, 2020

(54) TERMINAL OPERATING METHOD AND TERMINAL

(71) Applicant: AAC Technologies Pte. Ltd., Singapore city (SG)

(72) Inventor: Xufeng Zhang, Shenzhen (CN)

(21) Appl. No.: 16/043,491

(22) Filed: Jul. 24, 2018

(51) Int. Cl. G06F 3/041; G06K 9/00; H04M 1/725

(52) U.S. Cl. CPC G06F 3/0416; G06K 9/00087; G06F 3/0412; G06F 2203/0381; H04M 1/72563

(57) ABSTRACT

A terminal and a terminal operating method are provided. The present disclosure relates to technical field of the terminals, which can reduce the situation of the user's inability to operate the terminal to a certain extent when liquid such as water is present on the hand, and thus improve efficiency of terminal application. The terminal operating method in the present disclosure includes: collecting trajectory information of a touch device; comparing the trajectory information with preset trajectory information and judging whether attached liquid is present on a designating function module; collecting audio information if determining that attached liquid is present on the designating function module; determining instruction information corresponding to the audio information according to the audio information; and completing a corresponding operation in response to the instruction information. The embodiments of the present disclosure are applicable to processes of terminal operations.

### TECHNICAL FIELD

The present disclosure relates to the field of terminal technologies and, in particular, to a terminal operating method and a terminal.

### BACKGROUND

In recent years, versatility of handheld mobile terminals such as smart phones or tablets has made them one of the necessities in people's life. At present, such mobile terminals are generally equipped with touch screens, which can be used to display the system interface, and can also collect the user's touch actions to complete interaction with a user.

The user can trigger the mobile terminal to enter the sleep state by actively setting a sleep mode, or if the mobile terminal is not used for a time period, the mobile terminal also automatically enters the sleep mode. After entering the sleep mode, the mobile terminal generally displays a black screen and enters a lock screen state. When the user wants to use it again, the mobile terminal must be woken up and unlocked to enable the mobile terminal to enter an awake state from the sleep state. Generally, the unlocking action needs to be performed after a hardware button is pressed to wake up the screen, and then a preset password is input via the touch screen, or a gesture is swiped or via a long press according to a unlocking prompt displayed in the touch screen, or a fingerprint identification device is pressed, so as to achieve the purpose of unlocking.

When a user is washing hands, washing clothes, or cooking, he/she often encounters a situation where a call is coming with a hand having water or a situation where important information needs to be viewed. In these cases, unlocking directly according to the related art may cause water stick to the touch screen. Therefore, the mobile terminal cannot recognize the user's unlocking operation, resulting in failure to implement the unlocking operation and affecting subsequent use of the user.

### BRIEF DESCRIPTION OF DRAWINGS

In order to more clearly illustrate technical solutions of embodiments of the present disclosure, the accompanying drawings used in the embodiments are briefly described below. The drawings described below are merely a part of the embodiments of the present disclosure. Based on these drawings, those skilled in the art can obtain other drawings without any creative effort.

FIG. 1 is a flowchart of a terminal operating method according to an embodiment of the present disclosure;

FIG. 2 is a flowchart of another terminal operating method according to an embodiment of the present disclosure;

FIG. 3 is a block diagram of a terminal according to an embodiment of the present disclosure; and

FIG. 4 is a block diagram of another terminal according to an embodiment of the present disclosure.

### DESCRIPTION OF EMBODIMENTS

In order to more clearly illustrate technical solutions of embodiments of the present disclosure, the accompanying drawings used in the embodiments are briefly described below. The drawings described below are merely a part of the embodiments of the present disclosure. Based on these drawings, those skilled in the art can obtain other drawings without any creative effort.

In order to better understand technical solutions of the present disclosure, the embodiments of the present disclosure are described in details with reference to the drawings.

It should be clear that the described embodiments are merely part of the embodiments of the present disclosure rather than all of the embodiments. All other embodiments obtained by those skilled in the art without paying creative labor shall fall into the protection scope of the present disclosure.

The terms used in the embodiments of the present disclosure are merely for the purpose of describing specific embodiments, rather than limiting the present disclosure. The terms “a”, “an”, “the” and “said” in a singular form in the embodiments of the present disclosure and the attached claims are also intended to include plural forms thereof, unless noted otherwise.

It should be understood that the term “and/or” used in the context of the present disclosure is to describe a correlation relation of related objects, indicating that there may be three relations, e.g., A and/or B may indicate only A, both A and B, and only B. In addition, the symbol “/” in the context generally indicates that the relation between the objects in front and at the back of “/” is an “or” relationship.

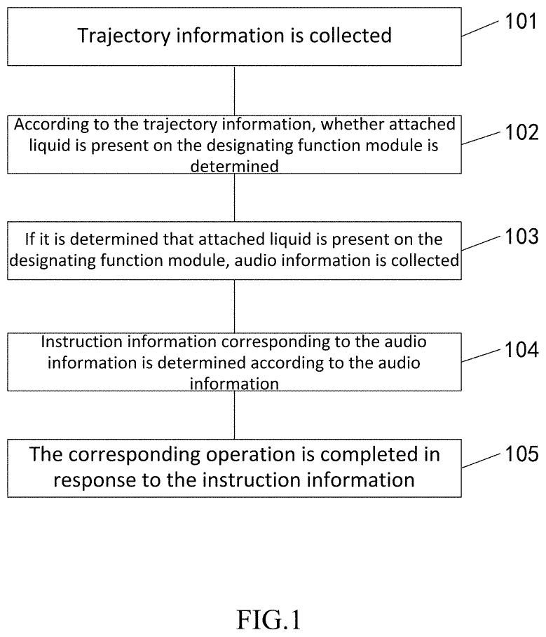

An embodiment of the present disclosure provides a terminal operating method. As shown in FIG. 1, the terminal operating method includes the following steps.

101. Trajectory information is collected.

The trajectory information is trajectory information corresponding to a touch operation entered by a user through a touch device (including a touch screen, a touch pad, a fingerprint recognition module, and the like). The trajectory information may include trajectories left on the touch device by various actions such as clicking, swiping, and long press.

102. According to the trajectory information, whether attached liquid is present on the designating function module is determined.

Since there is a certain amount of water or other conductive liquid attached to a hand, there may be some differences between the trajectory information collected by the terminal and the trajectory information corresponding to user's conventional use. For example, a region covered by the trajectory corresponding to an operating action with the attached water or other conductive liquid is larger than the region when the user conventionally uses, and in the former situation the region generally does not have a regular shape. Optionally, humidity of the region covered by the trajectory corresponding to attached water or other conductive liquid is detected.

Therefore, specific combinations of parameters such as pressure thresholds, capacitances, inductances, resistances, and the like may be specifically configured through these characteristics to determine whether the current trajectory information indicates that water or other conductive liquid is present in the touch process. Of course, these specific combinations of parameters can be calculated theoretically or experimentally.

In addition, the judging process is not limited to the current operation mode of the mobile phone, and no matter what mode (such as flight, black screen, standby, etc.) is, it is always in a judging state.

103. If it is determined that attached liquid is present on the designating function module, audio information is collected.

When liquid is attached to a hand, it is difficult for the user to use the hand to operate the touch screen or the fingerprint recognition module so as to complete the effective operation of the terminal. Therefore, in the embodiments of the present disclosure, a voice recognition manner may be enabled to complete interaction with the user. Collecting audio information is an important step to complete voice recognition.

In the process of collecting audio information, the collecting can be completed through an external headphone mic or a terminal body mic.

In addition, if determining that no attached liquid is present on the designating function module, the user can respond to the user's operation according to the normal operation mode of the terminal.

104. Instruction information corresponding to the audio information is determined according to the audio information.

Confirming the instruction information may be completed by voice recognition of the audio information, and may include unlocking, opening an unread message, dialing a XXX call, answering an incoming call, opening a XXX app or other terminal function.

105. The corresponding operation is completed in response to the instruction information.

With the terminal operating method according to the embodiments of the present disclosure, when detection that the user may be unable to normally operate the terminal due to the liquid such as water on the hand, the user's operation intention is completed by performing voice interaction with the user, thus reducing the situation of the user's inability to operate the terminal to a certain extent when liquid such as water is present on the hand, and thus improving efficiency of terminal application.

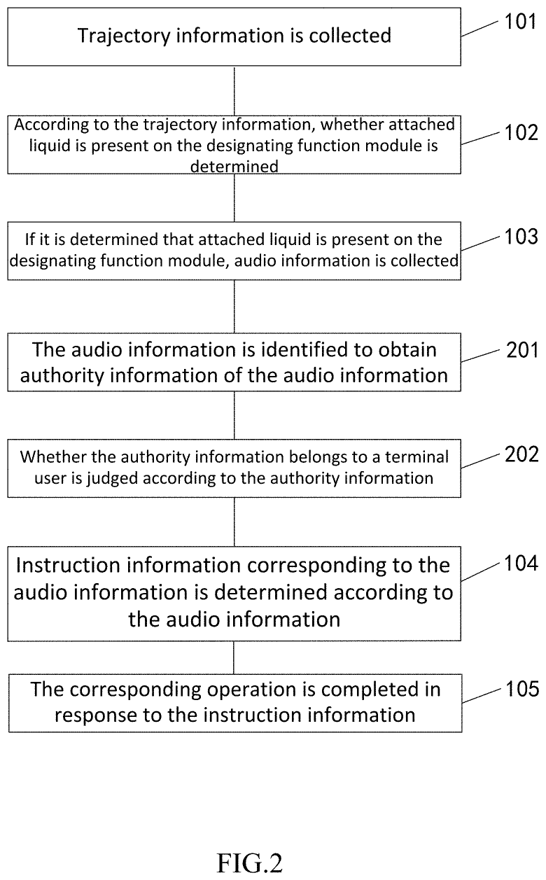

In order to prevent non-owner of the terminal from completing the operation of the terminal bypassing the normal unlocking process through the foregoing process, the embodiments of the present disclosure may also complete an authentication for the audio provider by verifying the collected audio information according to actual needs. The method is shown in FIG. 2, and further includes the following steps.

201. The audio information is identified to obtain authority information of the audio information.

The authority information may be physical characteristics corresponding to the audio information, such as voiceprint information, volume, and the like, or may be concrete contents obtained after semantic recognition according to the audio information, for example, a password, a preset keyword, and the like.

202: Whether the authority information belongs to a terminal user is judged according to the authority information. When the authority information belongs to the terminal user, the foregoing step 104 is performed, otherwise, the terminal does not respond, and maintain the current running state of the terminal, or adjust the terminal to a sleep state, or close the terminal.

Of course, in the embodiments of the present disclosure, whether attached liquid is present can also directly detected by directly setting a liquid detection element in the designating function module. The method includes the following steps.

Step 1: presence of attached liquid is detected by a liquid detection element on a designating function module;

Step 2: audio information is collected if it is determined that attached liquid is present on the designating function module;

Step 3: instruction information corresponding to the audio information is determined according to the audio information; and

Step 4: a corresponding operation is completed in response to the instruction information.

The liquid detection element may be a humidity sensor or a pressure sensor.

In addition, the foregoing respective method processes provided in the embodiments of the present disclosure may be configured in an independent operation mode, such as liquid attachment mode and the like. The way of enabling this mode can be actively triggered by the user or automatically initiated by the terminal according to specified configuration parameters.

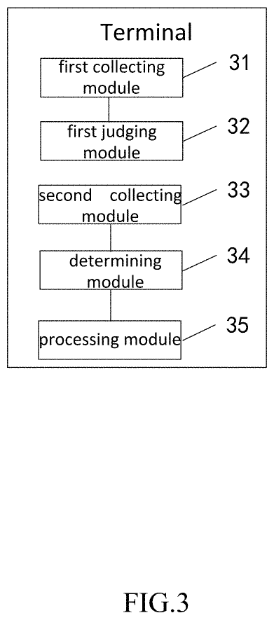

An embodiment of the present disclosure further provides a terminal, which can be used to implement the foregoing respective method processes, and the composition thereof is shown in FIG. 3. The terminal includes:

a first collecting module 31, configured to collect trajectory information;

a first judging module 32, configured to judge whether attached liquid is present on the designating function module according to the trajectory information;

a second collecting module 33, configured to collect audio information if it is determined that attached liquid is present on the designating function module;

a determining module 34, configured to determine instruction information corresponding to the audio information according to the audio information;

a processing module 35, configured to complete a corresponding operation in response to the instruction information.

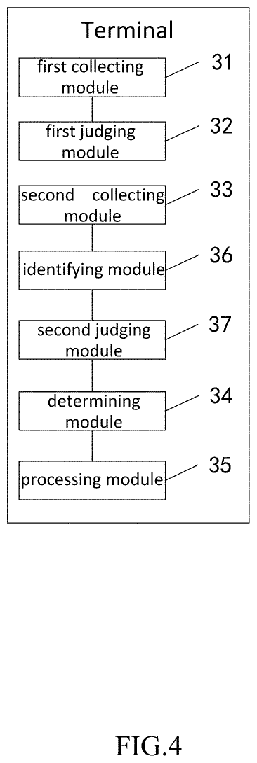

In some embodiments, as shown in FIG. 4, the terminal further includes:

an identifying module 36, configured to identify the audio information and obtain authority information of the audio information;

a second determining module 37, configured to determine whether the authority information belongs to a terminal user according to the authority information;

the determining module 34, further configured to determine the instruction information corresponding to the audio information according to the audio information if the authority information belongs to the terminal user.

In some embodiments, the determining module 34 is further configured to maintain a current operating state of the terminal or close the terminal if the authority information does not belong to the terminal user.

In some embodiments, the designating function module includes a touch screen and a fingerprint recognition module.

With the terminal operating method according to the embodiments of the present disclosure, when detecting that the user may be unable to normally operate the terminal due to the liquid such as water on the hand, the user's operation intention is completed by performing voice interaction with the user, thus reducing the situation of the user's inability to operate the terminal to a certain extent when liquid such as water is present on the hand, and thus improving efficiency of terminal application.

Those skilled in the art can clearly understand that, for convenience and conciseness of description, the working processes of the above-described systems, devices, and modules may refer to the corresponding processes in the foregoing method embodiments, which are not elaborated herein.

In some embodiments according to the present disclosure, it should be understood that the disclosed systems, devices, and methods can be implemented in other ways. For example, the device embodiments described above are merely schematic, for example, the division of the modules is only one logical function division, and actual implementation may have other division manners. For example, a plurality of modules or components may be combined or may be integrated into another system, or some features can be ignored or not executed. In addition, the illustrated or discussed mutual coupling or direct coupling or communication connection may be indirect coupling or communication connection through some interfaces, devices or modules, and may be electrical, mechanical or in other forms.

The modules described as separate components may or may not be physically separated, and the components displayed as the modules may or may not be physical modules, that is, they may be located in one place, or may be distributed in multiple network modules. Some or all of the modules may be selected according to actual requirements to realize the purpose of the solution of the embodiments.

In addition, each of the functional modules according to the respective embodiments of the present disclosure may be integrated in one processing module, or each module may physically exist alone, or two or more modules may be integrated in one module. The above-mentioned integrated module can be implemented either in a form of hardware or in a form of hardware plus software functional modules.

The above-described integrated module implemented as a software functional module may be stored in a computer-readable storage medium. The above software function modules are stored in a storage medium, and include a plurality of instructions for enabling a computer device (may be a personal computer, a server, or a network device, etc.) or a processor to perform the steps of the method described in the respective embodiments of the present disclosure. The foregoing storage medium includes: a U disk, a removable hard disk, a Read-Only Memory (ROM), a Random Access Memory (RAM), a magnetic disk, an optical disk, or any other medium that can store program codes.

The foregoing embodiments are merely preferred embodiments of the present disclosure and are not intended to limit the present disclosure. Any modifications, equivalent substitutions and improvements made within the spirit and principle of the present disclosure shall be included in the protection scope of the present disclosure.

What is claimed is:

1. A method for operating a terminal, comprising:
step 1: collecting trajectory information of a touch device;
step 2: comparing the trajectory information with preset trajectory information and judging whether there is liquid attached on a designating function module;
step 3: collecting audio information when there is liquid attached on the designating function module;
step 4: determining instruction information corresponding to the audio information according to the audio information; and
step 5: completing a corresponding operation in response to the instruction information.

2. The method according to claim 1, before step 4, further comprising steps of:
identifying the audio information to obtain authority information of the audio information;
judging whether the authority information belongs to a user of the terminal according to the authority information; and
when the authority information belongs to the user of the terminal, performing step 4.

3. The method according to claim 2, after the step of determining whether the authority information belongs to a user of the terminal according to the authority information, further comprising:
maintaining a current operating state of the terminal or turning off the terminal when the authority information does not belong to the user of the terminal.

4. The method according to claim 1, wherein the designating function module comprises a touch screen or a fingerprint recognition module.

5. A method for operating a terminal, comprising:
step 1: detecting, by a liquid detection element on a designating function module, whether there is liquid attached on the designating function module;
step 2: collecting audio information when there is liquid attached on the designating function module;
step 3: determining instruction information corresponding to the audio information according to the audio information; and
step 4: completing a corresponding operation in response to the instruction information.

6. The terminal operating method according to claim 5, wherein the liquid detection element is a humidity sensor or a pressure sensor.

7. A terminal, comprising:
a first collecting module, configured to collect trajectory information;
a first judging module, configured to judge whether there is liquid attached on a designating function module according to the trajectory information;
a second collecting module, configured to collect audio information when there is liquid attached on the designating function module;
a determining module, configured to determine instruction information corresponding to the audio information according to the audio information; and
a processing module, configured to complete a corresponding operation in response to the instruction information.

8. The terminal according to claim 7, further comprising:
an identifying module, configured to identify the audio information to obtain authority information of the audio information; and
a second judging module, configured to judge whether the authority information belongs to a user of the terminal according to the authority information,
wherein the determining module is further configured to determine the instruction information corresponding to the audio information according to the audio information, when the authority information belongs to the user of the terminal.

9. The terminal according to claim 8, wherein the determining module is further configured to maintain a current operating state of the terminal or turn off the terminal when the authority information does not belong to the user of the terminal.

10. The terminal according to claim 7, wherein the designating function module comprises a touch screen or a fingerprint recognition module.
